(19) United States
(12) Patent Application Publication
(10) Pub. No.: US 2024/0176043 A1
(43) Pub. Date: May 30, 2024

(54) METHODS AND SYSTEMS FOR AUTOMATIC WELL PLACEMENT PLANNING DURING RESERVOIR SIMULATION

(71) Applicant: SAUDI ARABIAN OIL COMPANY, Dhahran (SA)

(72) Inventor: Babatope Kayode, Dhahran (SA)

(73) Assignee: SAUDI ARABIAN OIL COMPANY, Dhahran (SA)

(21) Appl. No.: 18/509,962

(22) Filed: Nov. 15, 2023

Related U.S. Application Data
(60) Provisional application No. 63/385,555, filed on Nov. 30, 2022.

(51) Int. Cl. G01V 99/00

(52) U.S. Cl. CPC G01V 99/005

(57) ABSTRACT

Methods and systems are disclosed. The methods may include, using a reservoir simulator to obtain a reservoir simulation model including a grid of computational voxels, a free-water level boundary, and locations of pre-existing production wells and defining a set of candidate well locations within an area enclosed by the free-water level boundary. The methods may further include forming a set of candidate production well locations, where each well candidate production well location is greater than a first threshold distance from all pre-existing production wells and further than a second threshold distance from the free-water level boundary. The methods may also include determining a trajectory for lateral branches of each candidate production well and selecting a set of planned production well locations based on a ranking of combined predicted production rate from the lateral branches of each candidate production well and drilling a production well guided by the trajectories.

### BACKGROUND

Operators in the oil and gas industry plan their activity to maximize recovery of hydrocarbons, such as oil and/or gas, from subsurface hydrocarbon reservoirs while minimizing the production of unwanted fluid, such as wastewater, and minimizing investment costs. A common activity in the operation of a hydrocarbon reservoir is the drilling of new wells, either to access previously unproduced hydrocarbons, to inject fluids, such as water, to maintain reservoir pore pressure, or to gather additional geological, geophysical, or geochemical information about the hydrocarbon reservoir. Planning new wells may involve a search for locations that provide best instantaneous oil production rate while minimizing interference with neighboring wells. Traditionally, this is done by loading a model of the hydrocarbon reservoir into a 3D visualization software package to identify target locations manually. Cross-sections of the reservoir may be created to identify the reservoir layers to be targeted and in what direction the deviated or horizontal well should be oriented. The well trajectory is then designed and the design parameters, including (surface or downhole) starting point, target, trajectory, diameter (“caliper”) and completion design, are exported into a reservoir simulator to predict the expected production.

Reservoir simulators may use a physics-based reservoir simulations of the expected performance of proposed (“candidate”) wells. Performance may include hydrocarbon production rates, unwanted fluid (such as brine) production rates, as well as the effect of the production of existing wells and the estimated ultimate recoverable hydrocarbon. Simulation, using conventional techniques, may be both computationally and human resource intensive leading to long planning times and incomplete examination of all the potential options. In large reservoirs with significant permeability heterogeneities that require hundreds of development wells, conducting such scenario evaluations manually is often prohibitively time-consuming using traditional approaches, resulting in the partial evaluation of scenarios whose results may not allow for optimum decision-making. Consequently, an automated process for determining advantageous new well geometries is desirable.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments relate to methods. The methods may include obtaining, using a reservoir simulator a reservoir simulation model for a hydrocarbon reservoir, where the reservoir simulation model includes a grid of computational voxels representing the hydrocarbon reservoir, a free-water level boundary, and a location of each pre-existing production well. The methods may also include defining a set of candidate well locations within an area enclosed by the free-water level boundary and forming a first filtered set of candidate well locations, where each well location in the first filtered set of candidate well locations is greater than a first threshold distance from the location of all pre-existing production wells, and forming a set of candidate production well locations from the first filtered set, where each candidate well location in the set of candidate production well locations is further than a second threshold distance from the free-water level boundary. The methods may further include, using the simulation model, for each candidate production well location in the set of candidate production well locations determining a trajectory for each of a number of lateral branches of a well commencing at the location of the candidate production well; and determining, using the trajectory for each of the lateral branches of the well, a combined predicted production rate, and ranking the candidate production well locations based, at least in part, on the combined predicted production rate of each candidate production well location. The methods may further include selecting a set of planned production well locations based, at least in part on the rank of each candidate production well locations and drilling, using a drilling system, a production well guided by the trajectory of each lateral branch of the well commencing at the candidate production well location.

In general, in one aspect, embodiments related to a system including a reservoir simulator and a drilling system. The reservoir simulator may be configured to obtain a reservoir simulation model for a hydrocarbon reservoir, where the reservoir simulation model comprises a grid of computational voxels representing the hydrocarbon reservoir, a free-water level boundary, and a location of each pre-existing production well, define a set of candidate well locations within an area enclosed by the free-water level boundary, and form a first filtered set of candidate well locations, wherein each well locations in the first filtered set of candidate well locations is greater than a first threshold distance from the location of all pre-existing production wells. The reservoir simulator may be further configured to form a set of candidate production well locations from the first filtered set, wherein each candidate well location in the set of candidate production well locations is further than a second threshold distance from the free-water level boundary and using the reservoir simulation model, for each candidate production well location in the set of candidate production well locations, determine, using the reservoir simulation model, a trajectory for each of a number of lateral branches of a well commencing at the location of the candidate production well and determine, using the trajectory for each of the lateral branches of the well, a combined predicted production rate. The reservoir simulator may still further be configured to rank the candidate production well locations based, at least in part, on the combined predicted production rate of each candidate production well location and select a set of planned production well locations based, at least in part on the rank of each candidate production well locations. The drilling system may be configured to drill a production well guided by the trajectory of each lateral branch of the well commencing at the candidate production well location.

In general, in one aspect, embodiments are disclosed related to a non-transitory computer readable memory with computer-executable instructions stored thereon that, when executed on a processor, may cause the processor to perform steps including obtaining a reservoir simulation model for a hydrocarbon reservoir, wherein the reservoir simulation model comprises a grid of computational voxels representing the hydrocarbon reservoir, a free-water level boundary, and a location of each pre-existing production well, defining a set of candidate well locations within an area enclosed by the free-water level boundary, and forming a first filtered set of candidate well locations, wherein each well locations in the first filtered set of candidate well locations is greater than a first threshold distance from the location of all pre-existing production wells. The steps may also include forming a set of candidate production well locations from the first filtered set, wherein each candidate well location in the set of candidate production well locations is further than a second threshold distance from the free-water level boundary and using the simulation model for each candidate production well location in the set of candidate production well locations determining a trajectory for each of a number of lateral branches of a well commencing at the location of the candidate production well and determining, using the trajectory for each of the lateral branches of the well, a combined predicted production rate. The steps may further include ranking the candidate production well locations based, at least in part, on the combined predicted production rate of each candidate production well location and selecting a set of planned production well locations based, at least in part on the rank of each candidate production well locations.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 depicts a seismic acquisition system in accordance with one or more embodiments.

FIG. 2 shows a well log in accordance with one or more embodiments.

FIG. 3A depicts a reservoir model in accordance with one or more embodiments.

FIG. 3B depict production wells in accordance with one or more embodiments.

FIG. 4 depict a reservoir simulator in accordance with one or more embodiments.

FIG. 5 shows a flowchart in accordance with one or more embodiments.

FIG. 6A illustrates the determination of sweet-spots in accordance with one or more embodiments.

FIG. 6B illustrates the determination of sweet-spots in accordance with one or more embodiments.

FIG. 7 illustrates the determination of sweet-spots depict sweet-spots in accordance with one or more embodiments.

FIG. 8 depicts a hydrocarbon reservoir and wells in accordance with one or more embodiments.

FIG. 9 depicts a hydrocarbon reservoir and wells in accordance with one or more embodiments.

FIGS. 10A and 10B depicts geosteering drilling systems in accordance with one or more embodiments.

FIG. 11 shows a computer system, according to one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. Thus, for example, reference to a “well trajectory” includes reference to one or more of such trajectories.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the method may be omitted, repeated, and/or performed in a different order than the order shown. Accordingly, the scope disclosed herein should not be considered limited to the specific arrangement of steps shown in the method.

Although multiple dependent claims are not introduced, it would be apparent to one of ordinary skill that the subject matter of the dependent claims of one or more embodiments may be combined with other dependent claims.

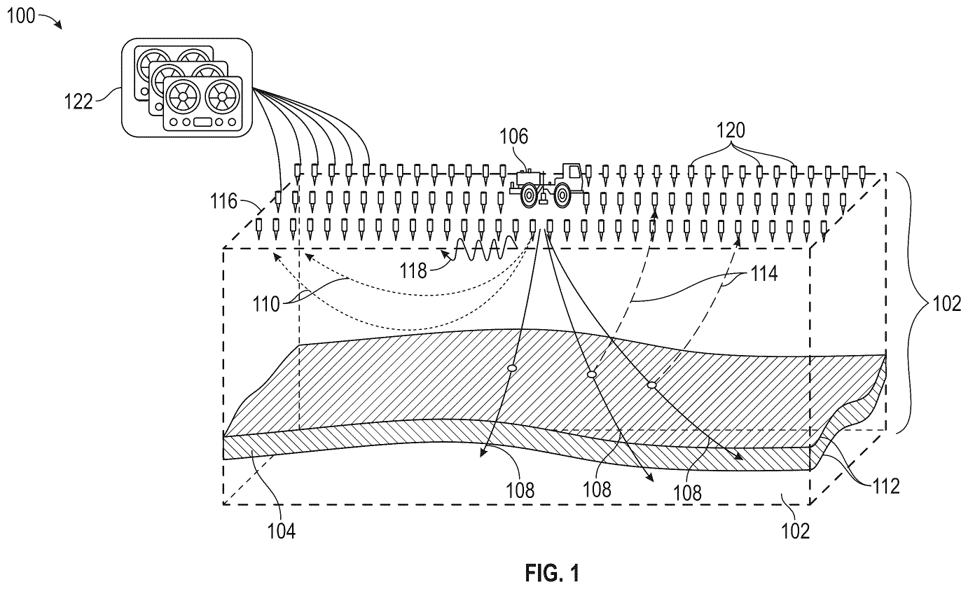

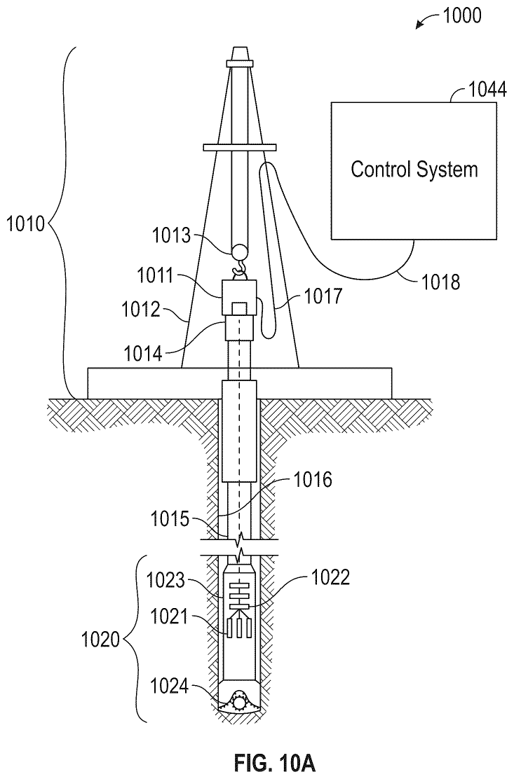

In the following description of FIGS. 1-11, any component described with regard to a figure, in various embodiments disclosed herein, may be equivalent to one or more like-named components described with regard to any other figure. For brevity, descriptions of these components may not be repeated for each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

The operation of a hydrocarbon reservoir typically requires the drilling of a plurality of wells over its productive life. For large fields, these wells may number in the hundreds or even thousands. These wells may include production wells and injection wells. Hydrocarbons are extracted through production wells, either using the pore fluid pressure within the reservoir alone to force the hydrocarbon to the surface or supplementing the pore fluid pressure with pumping systems, including both downhole and surface pumps. In contrast, injection wells inject fluids, typically fresh water or brine, intended to increase, maintain, or slow the decrease of the pore fluid pressure within the hydrocarbon reservoir over time.

New production wells may be drilled either in previously undeveloped portions of the hydrocarbon reservoir or between existing wells. Production wells drilled between existing wells may be termed “infill wells”, either to access previously undrained portions of the reservoir or to replace existing wells where the production of hydrocarbons is declining, or the production of undesirable fluids, such as brine, is increasing. New wells may be vertical wells, but typically new wells, particularly infill wells are highly deviated or horizontal wells whose deeper portions extend either deviated significantly from vertical or horizontally. The surface location and trajectory of new production wells and injection wells are typically planned with the help of reservoir models and reservoir simulations. Reservoir models typically contain a three-dimensional digital representation of the spatial distribution of rock characteristics, such as porosity and permeability, in the subterranean region of interest, as well as the trajectories and characteristics of existing production and injection wells. Reservoir simulations predict the percolation or flow of pore fluids under natural or anthropomorphic pressure and temperature conditions in the reservoir, including the prediction of fluid production by production wells.

Conventional methods for planning future hydrocarbon productions wells and water injection wells are intensively manual and rely on defining required parameters, such as well length, orientation and offset distance from the free-water level (FWL) or water table. This approach may be adequate in fairly homogeneous reservoirs where water saturation is generally constant and the FWL uniform across the reservoir although, even in relatively homogeneous reservoirs, conventional manual methods may be both time consuming and prone to error.

In highly heterogeneous reservoirs, where an interval containing high water saturation may separate two otherwise low water-high oil saturation intervals, conventional manual methods may not be adequate due to even greater time requirements and higher error rates. For these reservoirs, well design should incorporate the search for the reservoir sweet-spots, defined as the reservoir intervals having low water saturation and high permeability and porosity.

Embodiments are disclosed related to the application of automated methods to determine preferred combinations of lateral location and directions utilizing the identification of sweet-spots and in numerical reservoir simulations. These embodiments represent a novel application of automatic well placement optimization and an improvement over conventional method as measured by both the time required to perform the well placement and the reduction in error rates. In some cases, time saving of more than 90% may be obtained.

Development of an oil and gas field, including one or more hydrocarbon reservoirs typically requires the drilling of numerous wells. In addition to the discovery well(s) drilled to confirm the existence of a hydrocarbon reservoir, and one or more appraisal wells, drilled to delineate the spatial extent and petrophysical properties of the hydrocarbon reservoir, numerous production wells may be drilled to extract the hydrocarbons. The production wells may be planned with a number of objectives in mind: maximizing initial hydrocarbon production rate, minimizing wastewater production rate (“water cut”), minimizing hydrocarbon production decline with time, minimizing capital expenditure (such as drilling costs) and operating expenditure (such as treating and disposing of wastewater). These goals may often be in conflict and a balance between them may be sought. For example, minimizing decline rates may require the injection of fluid, typically water, through injection wells drilled around the periphery of the hydrocarbon reservoir to maintain reservoir pressure, even though the drilling of these injection wells increase capital expenditure. A qualitative or quantitative measure (“metric”) combining the extent to which each of these goals, and others well known in the art, are met for any given well may be termed the “performance of the well”, and for the reservoir as a whole, the “performance of the reservoir”.

To obtain an appropriate balance between these conflicting goals, a reservoir development plan may be formed prior to the drilling of production and injection wells. Initially, plan may be formed based upon a limited knowledge of the reservoir based upon remote sensing data acquired by sensors on the surface of the earth above the reservoir, petrophysical measurements (“well logs”) and samples (“cores”) of the reservoir formation taken from the discovery and appraisal wells. Remote sensing data may include seismic surveys, electromagnetic surveys, and gravity surveys.

As production and injection wells are drilled additional well logs and core samples may be acquired and knowledge of the characteristics of the reservoir may be updated and refined. In addition, the measured hydrocarbon production rates and water cuts may be recorded and used to further refine and update the knowledge of the reservoir. For example, the porosity of the reservoir formation, the relative fractions of gas, oil, and water, occupying the pores and the permeability, or ease with which pore fluids may flow through the reservoir may be estimated or updated.

### Input Data

An initial model of a hydrocarbon reservoir may be based upon remote sensing data acquired by sensors on the surface of the earth above the reservoir, petrophysical measurements (“well logs”) and samples (“cores”) of the reservoir formation taken from the discovery and appraisal wells. Remote sensing data may include seismic surveys, electromagnetic surveys, and gravity surveys.

FIG. 1 shows a seismic acquisition system (100) configured to acquiring a seismic dataset pertaining to a subterranean region of interest (102). The subterranean region of interest (102) may or may not contain a hydrocarbon reservoir (104). The purpose of the seismic survey may be to determine whether or not a hydrocarbon reservoir (104) is present within the subterranean region of interest (102).

The seismic acquisition seismic (100) may utilize a seismic source (106) positioned on the surface of the earth (116). On land the seismic source (106) is typically a vibroseis truck (as shown), or less commonly explosive charges, such as dynamite, buried to a shallow depth. In water, particularly in the ocean, the seismic source may commonly be an airgun (not shown) that releases a pulse of high-pressure gas when activated. Whatever its mechanical design, the seismic source (106) generates radiated seismic waves, such as those whose paths are indicated by the rays (108). The radiated seismic waves may be bent (“refracted”) by variations in the speed of seismic wave propagation within the subterranean region (102) return to the surface (116) as refracted seismic waves (110). Alternatively, radiated seismic waves may be partially or wholly reflected by seismic reflectors and return to the surface as reflected seismic waves (114). Seismic reflectors may be indicative of the geological boundaries (112), such as the boundaries between geological layers, the boundaries between different pore fluids, faults, fractures or groups of fractures within the rock, or other structures of interest in the seismic for hydrocarbon reservoirs.

At the surface, the refracted seismic waves (110) and reflected seismic waves (114) may be detected by seismic receivers (120). On land a seismic receiver (120) may be a geophone (that records the velocity of ground motion) on an accelerometer (that records the acceleration of ground motion). In water, the seismic receiver may commonly be a hydrophone that records pressure disturbances within the water. Irrespective of its mechanical design or the quantity detected, seismic receivers (120) convert the detected seismic waves into electrical signals, that may subsequently be digitized and recorded by a seismic recorder (122) as a time-series of samples. Such a time-series is typically referred to as a seismic “trace” and represents the amplitude of the detected seismic wave at a plurality of sample times. Usually, the sample times are referenced to the time of source activation and the sample times are referred to as “recording times”. Thus, zero recording time occurs at the moment the seismic source is activated.

Each seismic receivers (120) may be positioned at a seismic receiver location that may be denoted (xᵣ, yᵣ) where x and y represent orthogonal axes on the surface of the earth (116) above the subterranean region of interest (102). Thus, the refracted seismic waves (110) and reflected seismic waves (114) generated by a single activation of the seismic source (106) may be represented as a three-dimensional “3D” volume of data with axes (xᵣ, yᵣ, t) where t indicates the recording time of the sample.

Typically, a seismic survey includes recordings of seismic waves generated by one or more seismic sources (106) positioned at a plurality of seismic source locations denoted (xₛ, yₛ). In some case, one seismic source (106) may be used to acquire the seismic survey, with the seismic source (106) being moved sequentially from one seismic source location to another. In other cases, a plurality of seismic sources (106) may be used each occupying and being activated (“fired”) sequential at a subset of the total number of seismic source locations used for the survey. Similarly, some or all of the seismic receivers (120) may be moved between firing of the seismic source (106). For example, seismic receivers (120) may be moved such that the seismic source (106) remains at the center of the area covered by the seismic receivers (120) even as the seismic source (106) is moved from one seismic source location to the next. Thus, a seismic dataset, the aggregate of all the seismic data acquired by the seismic survey, may be represented as a five-dimensional volume, with coordinate axes (xᵣ, yᵣ, yₛ, yₛ, t).

To determine earth structure, including the presence of hydrocarbons, the seismic data set may be processed. Processing a seismic dataset includes a sequence of steps designed to correct for near-surface effects, attenuate noise, compensate for irregularities in the seismic survey geometry, calculate a seismic velocity model, image reflectors in the subterranean and calculate a plurality of seismic attributes to characterize the subterranean region of interest to determine a drilling target. Critical steps in processing seismic data include a seismic migration. Seismic migration is a process by which seismic events are re-located in either space or time to their true subsurface positions.

Seismic noise may be any unwanted recorded energy that is present in a seismic data set. Seismic noise may be random or coherent and its removal, or “denoising,” is desirable in order to improve the accuracy and resolution of the seismic image. For example, seismic noise may include, without limitation, swell, wind, traffic, seismic interference, mud roll, ground roll, and multiples. A properly processed seismic data set may aid in decisions as to if and where to drill for hydrocarbons.

A typical seismic dataset may be 100 Terabytes to 1 Petabyte in size, corresponding to between 10 trillion (10¹³) and 100 trillion (10¹⁴) data samples. Clearly, processing such a large volume of data manually, without the aid of computer system configured to process seismic data, is completely unfeasible. Such a specially configured computer system may be termed a seismic processor, or seismic processing system. In addition to extensive arrays of tightly linked computer processing units (“CPUs”) a typical seismic processing system will include large arrays of graphical processing units (“GPUs”) to execute parallel processing, banks of high-speed tape or hard-drive readers to read the data from storage, high-speed tape or hard-drive writers to output final or intermediate results, and high-speed communication buses to connect these elements.

Electromagnetic surveys are also used to characterize hydrocarbon reservoirs. Like seismic surveys, electromagnetic sensors may be place on the surface of the earth, either on land or seabed, or towed behind vessels in the ocean. In addition, electromagnetic sensors may be deployed from airborne platforms, such as helicopters, aircraft and drones. A controlled electromagnetic source may be used to generate electromagnetic fields within the earth, which are in turn detected and recorded by electromagnetic sensors. Furthermore, in some cases, the natural variations of the magnetic field of the earth causes by the incidence of the solar field may be used as a natural electromagnetic source. Embodiments using this natural electromagnetic source are referred to as “magneto telluric” methods. As with seismic data, electromagnetic data may be processed to produce images of the subsurface. Unlike seismic data, electromagnetic survey data are directly sensitive to the electrical resistivity of the subsurface formations which is, in turn, strongly influenced by the pore fluid resistivity. High resistivities are typically indicative of hydrocarbons within the pores while low resistivity may be indicative of water/brine.

Like magneto-telluric methods, gravity surveys do not require an active source. Gravity surveys may be conducted using terrestrial, ship-mounted, or airborne sensors, that measure spatial variation in the gravity field of the earth. The resulting spatially varying gravity field data may be inverted to determine the spatial distribution of density within the subsurface. Such variations of density may be directly or indirectly indicative of the presence of hydrocarbons. For example, rocks with pores filled with natural gas may be less dense that rocks with pores filled with water, or oil.

While remote sensing data can provide field-wide information about the reservoir structure and rock characteristics, such information is frequently of limited resolution and require calibration with more detailed and precise, but sparser, measurements. For example, well logs acquired along all or part of a well may be recorded. Well logs may include, without limitation, measurement of resistivity, spontaneous potential, acoustic wave speed, natural gamma ray emission, gamma rays stimulated by pulsed neutrons, nuclear magnetic resonance. In particular, pulsed neutron logs (PNL) may be acquired and used to determine the fraction of pore volume (“saturation”) occupied by water rather than oil or gas.

Typically, well logs may acquire a sample measurement every six inches (15 cm) along a well trajectory. From these measurements rock characteristics such as porosity, permeability, and pore fluid constituents, such as water saturation, may be determined. Well logs may be acquired from logging tools conveyed on wireline, coiled tubing, or drillpipe, either during or after drilling. Typically, wireline logs are measured downhole and the data transmitted through communication cables woven into the wireline to surface and recorded there. Measurement-while-drilling (MWD) and logging-while-drilling (LWD) logs are also measured downhole. While in some cases MWD and LWD data are transmitted to surface by mud-pulse telemetry, wired-drillpipe telemetry or low-frequency/low-bandwidth electromagnetic telemetry, typically the measured data is stored downhole and retrieved later when the logging tool is recovered to the surface.

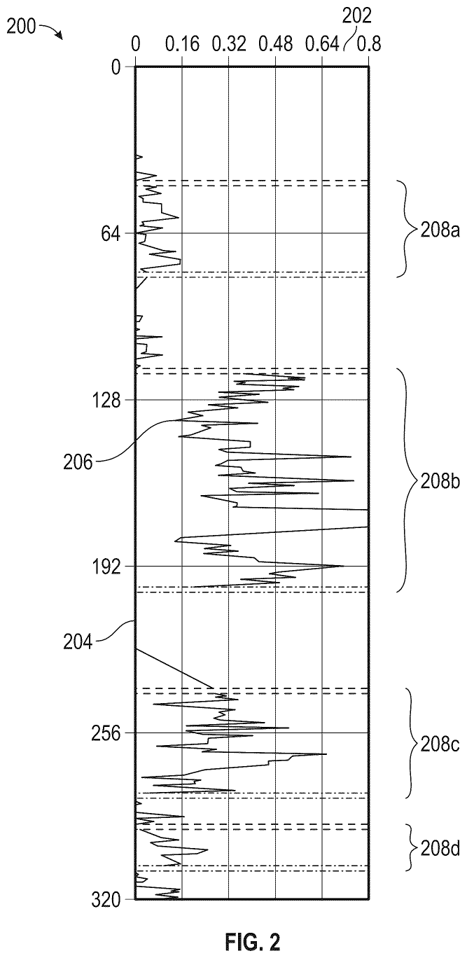

For example, FIG. 2 shows a well log, specifically a pulsed neutron log (200), with the measured value indicated by the horizontal axis (202) and the depth measured on the vertical axis (204). In some embodiments, the depth is vertical depth in other embodiments the depth may be “measured depth”, i.e., the distance along the, potentially deviated, wellbore. The measurement versus depth (or in some embodiments versus logging time) curve (206), of one or more physical quantities in or around a well is referred to as a “well log” or sometime simply a “log”. Specifically, in FIG. 2 the well log (206) shows a pulsed neutron measurement at each depth. Well logs, such as the pulsed neutron log (200), may be interpreted individually or collectively, to provide information about the subsurface region penetrated by the well. For example, the layers, such as layers (208a-d) with high water saturation values may be identified.

PNL logs measure the decay time of a short-lived neutron pulse. They probe the formation with neutrons but detect gamma rays generated by the interaction of the gamma rays with the rock and pore fluids. Chlorine has a particularly large capture cross section for neutrons at the energies used by pulsed neutron tools. If the chlorine in the pore fluid (brine) dominates the total neutron capture losses, a neutron-lifetime log will track chlorine concentration and, thus, the bulk volume of water in the formation. For constant porosity, the log will track pore water saturation, S_{w}. The neutrons are little affected by casing, including steel casing, so this is the standard cased-hole saturation tool. Like other nuclear tools, modern PNL tools may incorporate two detectors for wellbore compensation (a correction for variable wellbore diameter). These detectors also permit the calculation of a ratio porosity.

The basis of operation is similar to the other nuclear radiation transport tools in that the tool infers a cross section. In this case, the tool measures the time required for a pulse of neutrons to be absorbed by a formation. The mechanism by which the neutrons disappear is primarily thermal neutron capture. The time evolution of a pulse of neutrons follows the usual exponential decay law:

$${N}_{t} = {N}_{0} {e}^{- \frac{{\sum }_{a b s}}{4550} t} \qquad Eqn . ( 1 )$$

where Σ_{abs} is the total neutron capture cross section of the formation expressed in capture units (c.u.=1000×cm2/cm3, which has units of cross-sectional area per unit volume). The total capture cross section for a formation follows the standard linear volumetric mixing law discussed above:

Σ_{abs}=ΣᵢⁿVᵢΣᵢ, Eqn. (2)

where Vᵢ is the volume of a particular constituent (mineral or fluid) of a formation and Σᵢ is the capture cross section of each constituent. Because the corrected tool reads the total capture cross of the formation, this equation forms the basis of interpretation. For example, in the case of a clean sand with a porosity that is filled with oil and water, the tool reading will be

Σ_{abs}=(1−ϕ)Σ_{quartz}+ϕS_{w}Σ_{w}+ϕ(1−S_{w})Σₒᵢₗ Eqn. (3)

where Σ_{quartz} and Σₒᵢₗ are the capture cross sections of quartz and oil respectively. If porosity is known either from openhole logging or the ratio porosity measured by the pulsed neutron tool itself, the various cross sections can be looked up in a table (derived, for example, from controlled laboratory measurements) and it is a simple matter to solve for S_{w}.

The acquisition of Pulsed Neutron Log (PNL), such as PNL (200) on existing wells to determine water saturation may help to detect un-swept reservoir zones to be targeted with sidetrack wells.

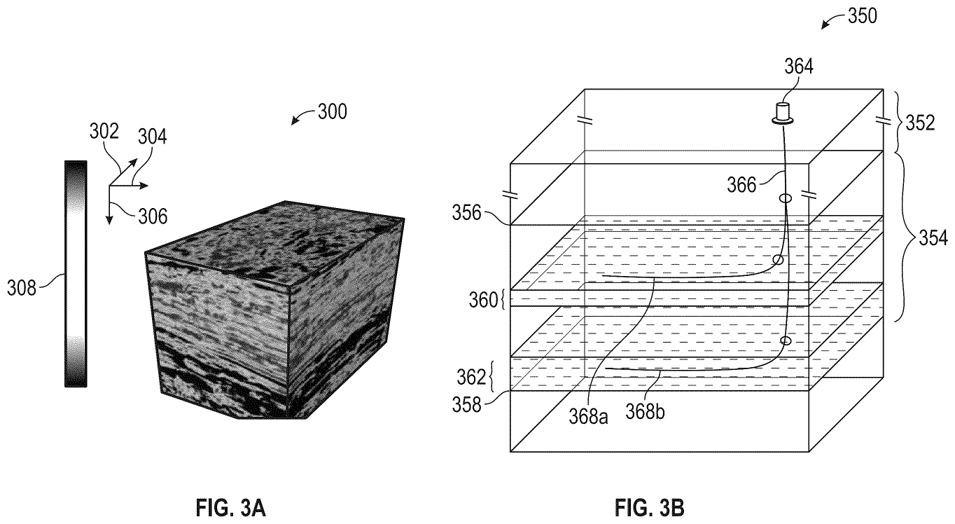

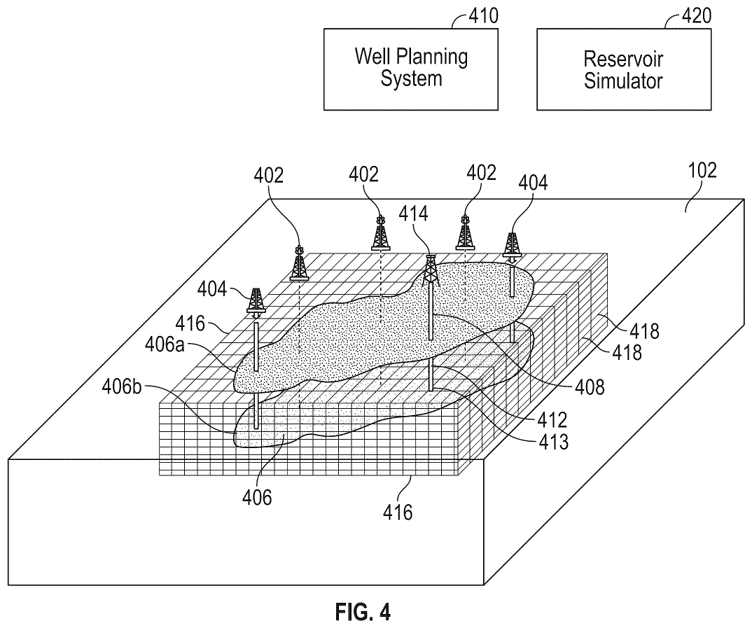

FIG. 3A shows a portion of a reservoir model (300). The portion of the reservoir model depicts rock formation characteristics of a reservoir as a function of horizontal position, indicated by the orthogonal axes (302) and (304) and as a function of depth indicated by the axis (306). Axis (306) is orthogonal to both axis (302) and axis (304). The value of the characteristic at each position within the portion of the reservoir model (300) is indicated by the grayscale (308). The characteristics forming the reservoir model may include, without limitation, porosity or permeability of the rock and oil, gas, or water saturation of the pores within the rock. Further, the initial values of the characteristics may be determined from remote sensing data, such as that acquired by seismic, electromagnetic, and gravity surveys. The determination of the characteristic may be performed by deterministically or statistically inverting seismic, electromagnetic and gravity data individually or in combination. The values of the characteristics forming the initial reservoir model may be updated and refined using well log data from wellbores as they are drilled through the exploration, appraisal and development stages of the life of the reservoir.

FIG. 3B shows a simplified portion of the subsurface (350) including an overburden portion (352) above a reservoir portion (354). The reservoir portion may contain a hydrocarbon reservoir bounded by an upper reservoir surface (356) and a lower reservoir surface (358). The upper reservoir surface may typically lie ten thousand feet or more below the surface of the earth. The reservoir portion (354) may be represented by the reservoir model (300) shown in FIG. 3A.

The hydrocarbon reservoir between the upper surface (356) and the lower surface (358) may typically be heterogeneous with characteristics, such as porosity and water saturation, that vary vertically and horizontally. Portions of the hydrocarbon reservoir with properties advantageous for hydrocarbon production, such as high porosity and low water saturation may be termed “sweet-spots”, such as sweet-spots (360) and (362) and targeted with production wells. Although in FIG. 3B sweet-spots (360) and (362) are shown as being laterally homogeneous, in many cases sweet-spots may vary laterally as well as vertically.

In some embodiments, development wells, such as production wells (366) and injection wells (not shown) may be drilled. Production wells (366) may be drilled all the way from surface locations, such as surface locations (364), to penetrate sweet-spots (360) and (362) with the objective of draining hydrocarbons from the sweet-spots. Some embodiments the production well (366) may have a single lateral (not shown). However, in other embodiments, sweet-spots may be targeted by two laterals, such as laterals (368a) and (368b). In still other embodiments three or more laterals may be drilled from a single surface location (364).

Multilateral wells may be drilled from a surface location (364) in two phases. A first lateral, such as lateral (368a) may be drilled from the surface location (364). Such as well may include an essentially vertical section from the surface followed by a section of increasing deviation from the vertical and an approximately horizontal section. The section with increasing deviation and the horizontal section may be drilled using geosteering techniques well known in the art and outlined below. After completion of the first lateral a whipstock assembly may be locked in place within the well, often within the vertical section of the well. The whipstock directs a casing milling bit to cut or grind a portion of the casing within the well at a defined angle (azimuth). Once the milling bit has cut through the casing it is replace with a geosteering bottomhole assembly and drill bit and the multilateral well is drilled using the geosteering bottomhole assembly and geosteering techniques described below.

In one or more embodiments, the wells may include casing. Typically, casing consists of steel tube of approximately 30 ft in length attached to one another at casing joints to form a continuous conduit within the well. The casing provides mechanical support to the wellbore to prevent collapse and fluidly isolates the well from the subsurface formation, preventing the inflow of gas, oil or water along the cased section. When casing is present, in portions of the wellbore where it is desired that fluid (oil and gas) enters the wellbore the casing must be perforated, i.e., holes must be created in the casing. Typically, this is achieved with a perforating gun that is lower on wireline or slickline within the casing to a desired location. Explosive charges within the perforating gun are then fired to generate the required hole. Determining the intended location of perforations in either a mother well or multilaterals is part of the process of planning the well. Obviously, wells that are perforated in hydrocarbon bearing sweet-spots, and not perforated in high water saturation zones, will typically produce more oil and less water.

Reservoir development and well placement plans are typically driven by physics-based reservoir simulation forecasts or predictions. The predictions required from simulation include the quantity of hydrocarbon in place in the reservoir, and the performance of various scenarios of well design, well count and resulting predicted hydrocarbon recovery volumes. The initial reservoir model may be used to formulate the reservoir production plan. Traditionally, given the distribution of petrophysical parameters within the reservoir, a plurality of candidate well trajectories may be proposed by an engineer and the predicted production and water cut over time may be simulated using a physics-based reservoir simulator. For example, the well design scenarios could consider the minimum thickness of the reservoir formation, the maximum water saturation of the targeted reservoir formation intervals, the minimum permeability of target reservoir interval, well length, etc. These different scenarios would result in different well counts and consequently in different hydrocarbon recovery volumes and capital expenditures.

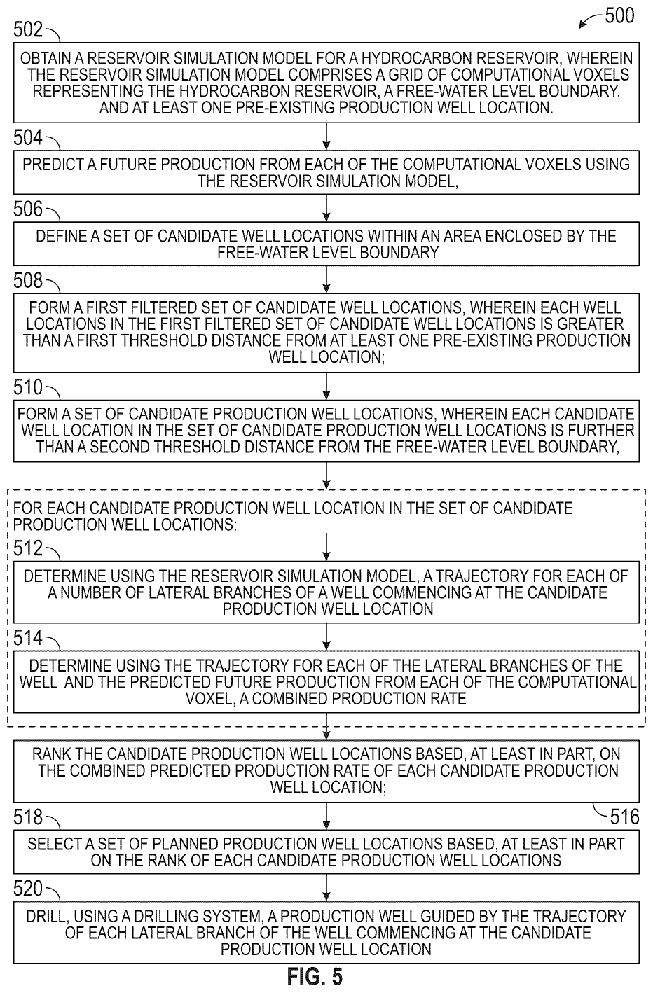

FIG. 4. depicts a hydrocarbon reservoir in accordance with one or more embodiments. As illustrated in FIG. 1, a subterranean region (102) may include one or more hydrocarbon reservoirs (406) with various production wells (402). Likewise, a hydrocarbon reservoir region may also include one or more injection wells (404) that include functionality for enhancing production by one or more neighboring production wells. For example, injection wells (404) may inject fluid to maintain reservoir pressure and to sweep hydrocarbon, such as oil and gas, through the hydrocarbon reservoir towards the production wells. As shown in FIG. 4, wells may extend from the surface of the Earth through various overburden layers to penetrate the hydrocarbon reservoir that may be bounded by an upper reservoir surface (406a) and a lower reservoir surface (406b).

In accordance with one or more embodiments, a reservoir model may be created or obtained for the hydrocarbon reservoir. Typically, the reservoir model may represent of the spatial variation of reservoir properties. For example, the reservoir properties may include the geometry of the reservoir, including the location of the geological boundaries that define the upper and lower surfaces of the reservoir and the location of any geological faults, fracture and fracture swarms within the reservoir. The reservoir properties may also include physical properties such as, without limitation, electrical resistivity, self-potential, acoustic wave propagation velocity, density, gamma-ray emission and the pressure of the reservoir fluid and the temperature of the reservoir. The reservoir properties may also include information derived, inverted, or interpreted from these physical properties, such as rock or “facies” types, e.g., carbonate, sandstone, shale, salt. Further, reservoir properties may include characteristic of particular importance to the study of reservoir fluid percolation through the reservoir. Specifically, reservoir properties may include porosity, quantifying the amount of volume between the grains of a rock per unit volume of bulk rock, that may be occupied by reservoir fluid; permeability quantifying the ease with which reservoir fluids may percolate through the rock; the initial pressures of the reservoir fluid and the temperature of the reservoir. Further, the reservoir properties may include the composition of the reservoir fluids, and their phases, i.e., liquid or gas. The reservoir model may also include the trajectories, completion data and production histories for a plurality of existing wells, and the proposed trajectories of potential future wells.

Such a reservoir model may be produced using deep sensing measurements, such as seismic surveys, gravity surveys, and electromagnetic surveys. In addition, the reservoir model may include information from well logs, acquired using wireline, coiled tubing, and drill pipe conveyed tools and acquired during or after the drilling of wells. In addition, the reservoir model may include information from core samples acquired as whole-core or as side-wall cores.

A reservoir modeling system may be used to generate the reservoir model, including receiving the measurement and data described in the preceding paragraphs, integrating, interpreting and displaying the data in a manner in which the reservoir model may be interrogated by operators of the hydrocarbon reservoir. Such a reservoir model may be created once, or more likely may be created and/or modified many times over the productive life of the hydrocarbon reservoir as additional information about reservoir properties are acquired and as the history of reservoir fluid production is extended. The reservoir model may include a plurality of cells, including three-dimensional cells or voxels (418), each associated with the rock and fluid properties of a volume sample of the hydrocarbon reservoir.

FIG. 1 also shows a well planning system (410) that may be used to contemplate planned wells (408) (e.g., planned wellbore path (412)) to penetrate the hydrocarbon reservoir (406) at a location (413). Wellbores may be drilled along a trajectory guided by the planned wellbore path (412) using a drilling system (414). Although FIG. 4 shows, for clarity, only a handful of vertical wells, this simplification is not intended to limit the scope of the invention in anyway. Realistic hydrocarbon reservoirs may contain hundreds, or thousands, of wells each of which may be vertical, highly-deviated, or horizontal and which may contain multiple branches (“multilaterals”) from a single parent wellbore.

For example, to determine the best drilling target for a single proposed well (i.e., to “perform a sweet-spot analysis”), it may be necessary to predict potential oil and gas production rates on a map of the subsurface, using various geologic and geophysical attribute maps (e.g., porosity, density, seismic attributes, gravity, magnetic, etc.) and the initial oil and gas production rates of several wells located in the area of interest vicinity of the proposed well.

In some embodiments, a physics-based reservoir simulator includes functionality for simulating the flow of fluids, including hydrocarbon fluids such as oil and gas, through a hydrocarbon reservoir composed of porous, permeable reservoir rocks in response to natural and anthropogenic pressure gradients. The physics-based reservoir simulator may be used to predict changes in fluid flow, including fluid flow into wells, particularly multilateral wells, penetrating the reservoir as a result of planned well drilling, fluid injection and extraction. For example, the physics-based reservoir simulator may be used to predict changes in hydrocarbon production rate that would result from the injection of water into the reservoir from wells around the periphery of the reservoir.

The physics-based reservoir simulator may use the reservoir model containing a digital description of the physical properties of the rocks as a function of position within the reservoir and the fluids within the pores of the porous, permeable reservoir rocks at a given time. In some embodiments, the digital description may be in the form of a dense 3D grid with the physical properties of the rocks and fluids defined at each node, such as that depicted in FIG. 3A. In some embodiments, the 3D grid may be a cartesian grid, while in other embodiments the grid may be a hexagonal grid or an irregular grid.

Physics-based reservoir simulators solve a set of mathematical governing equations that represent the physical laws that govern fluid flow in porous, permeable media. For example, the flow of a single-phase slightly compressible oil with a constant viscosity and compressibility the equations capture Darcy's law, the continuity condition and the equation of state and may be written as:

∇²p(x,t)=(φμcₜ)/k^{∂p(x,t)}/∂t Eqn. (4)

where p represents fluid in the reservoir, x is a vector representing spatial position and t represents time. φ, μ, cₜ, and k represent the physical and petrophysical properties of porosity, fluid viscosity, total combined rock and fluid compressibility, and permeability, respectively. ∇² represents the spatial Laplacian operator.

Additional, and more complicated equations are required when more than one fluid, or more than one phase, e.g., liquid and gas, are present in the reservoir. Further, when the physical and petrophysical properties of the rocks and fluids vary as a function of position the governing equations may not be solved analytically and must instead be discretized into a grid of cells or blocks. The governing equations must then be solved by one of a variety of numerical methods, such as, without limitation, explicit or implicit finite-difference methods, explicit or implicit finite element methods, or discrete Galerkin methods.

The physics-based reservoir simulator requires significant computational resources to predict the performance of the well from the spatial distribution of petrophysical parameters within the reservoir and the trajectories of the wells. Similarly, the number of candidate number of wells may be extremely large. Consequently, the traditional planning method are costly and time consuming uses of both computer and human resources. Furthermore, traditional methods traditionally explore only a small fraction of potential candidate well trajectories and are subject to human biases and error. For example, in a large reservoir with significant vertical heterogeneities several hundred production wells may be required. Conducting these scenario evaluations could be time consuming and only achieve partial evaluation of all the potential scenarios, thus preventing fully informed decision making.

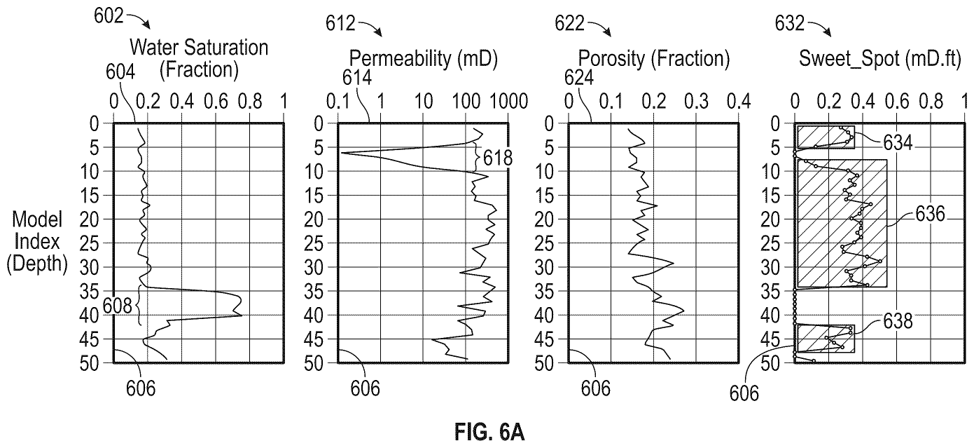

FIG. 5 shows a flowchart (500) in accordance with one or more embodiments. Flowchart (500) shows a process for automatically locating production wells and determining the number and trajectory of laterals and ranking and drilling a portion of them. Methods in accordance with one of more embodiments are summarized in FIG. 5 and are further illustrated with an example below.

In Step (502) a reservoir simulation model for a hydrocarbon reservoir may be obtained. The reservoir simulation model may include a grid of computational voxels representing the hydrocarbon reservoir, a free-water level boundary, and a location of each pre-existing production well. Further the reservoir simulation model may contain rock characteristics or properties, such as porosity, permeability, and pore fluid composition including water saturation, for each of the computational voxels. The free-water level may be a map of the depth of the contact between the pore fluid being primarily fresh water or brine and the pore fluid being primarily hydrocarbon, including oil and/or gas.

In Step (504) a set of candidate well locations may be defined within an area enclosed by the free-water level boundary. In some embodiments, the locations of set of candidate well may form a two-dimensional grid on the surface of the earth spaced at an equal interval from one another. In other embodiments, the locations of set of candidate well may be chosen at irregular or random intervals, wherein the irregularity may be constrained by surface logistical factors, such as the distance to the nearest road.

In some embodiments, a set of well locations make specified on a regular grid covering an area wholly enclosing the boundary of the free-water level. For example, the set of well location ay be specified on a Cartesian grid forming a rectangle that covers the area enclosing the boundary of the free-water level and extending beyond the boundary of the free-water level. These wells may be called field coverage wells (“FCW”) and may lie both inside and outside the boundary . The set of candidate well locations may be selected from the FCWs be selecting only the FCW locations that lie within the free-water level boundary. The wells forming the set of candidate well locations may also be termed filter field coverage wells (“FFCW”).

In Step (506) a first filtered set of candidate well locations may be formed, where each well locations in the first filtered set of candidate well locations is greater than a first threshold distance from the location any and all pre-existing production wells.

In Step (508) a set of candidate production well locations may be formed from the first filtered step of candidate well locations, where each candidate well location in the set of candidate production well locations is further than a second threshold distance from the free-water level boundary. Further, in some embodiments a set of candidate injection well locations from the first filtered set of candidate well locations may be formed. Each candidate well location in the set of candidate injection well locations may be closer than a second threshold distance to the free-water level boundary. In some embodiments, a set of injection well locations may be chosen, where each injection well location in the set of injection well locations occupy a position on the free-water level boundary closest to its corresponding candidate injection well location in the set of candidate injection well locations.

In Step (511) sweet-spots may be determined beneath each candidate production well location. The sweet-spots may be determined based upon the porosity, permeability and water saturation of the reservoir formation at different depths below each of the candidate production well locations. For example, depths with high porosity, high permeability and low water saturation

In Step (512), for each candidate production well location in the set of candidate production well locations, a trajectory for each of a number of lateral branches of a well commencing at the candidate production well location may be determined using the reservoir simulation model. In some embodiments, determining a trajectory may include determining sweet-spot voxels beneath the candidate production well location, where sweet-spot voxels are computational voxels with a permeability greater than a permeability threshold, a porosity greater than a porosity threshold, and a water saturation threshold less than a water saturation threshold. Further, in some embodiments, sweet-spot layers may be formed by merging sweet-spot voxels separated from one another by less than a depth separation threshold. Furthermore, sweet-spot layers may be selected with a thickness greater than a thickness threshold. The trajectory for each sweet-spot layer may be determined using a user specified direction and with a user specified length.

In Step (514) a combined production rate for each production well, including the contribution from each lateral, may be determined using the trajectory for each of the lateral branches of the well and the reservoir simulator.

In Step (516), in accordance with some embodiments, candidate production well locations may be ranked based, at least in part, on the combined predicted production rate of each candidate production well location. In other embodiments the ranking may include other factors, such as the cost of drilling the planned laterals. For example, the ranking may be performed based on a cost-normalized combined production rate.

In Step (518) a set of planned production well locations may be selected based, at least in part on the rank of each candidate production well locations. For example, the 20 candidate production well locations with the highest combined predicted production rate may be selected. Alternatively, all the candidate production well locations with the combined predicted production rates greater than a user selected threshold may be selected. Other criteria for selection may be used without departing from the scope of the invention. Furthermore, in some embodiments, the predicted combined production rate for each candidate production well location may be updated using the reservoir simulator based, at least in part, on the set of planned production well locations and the reservoir simulation model.

In Step (520) one or more production wells may be drilled using a drilling system guided by the trajectory of each lateral branch of the well commencing at the candidate production well location. The drilling, guided by the trajectory of each lateral branch, may include performing geosteering, and the drilling of the production well comprises a drilling multilateral well geometry.

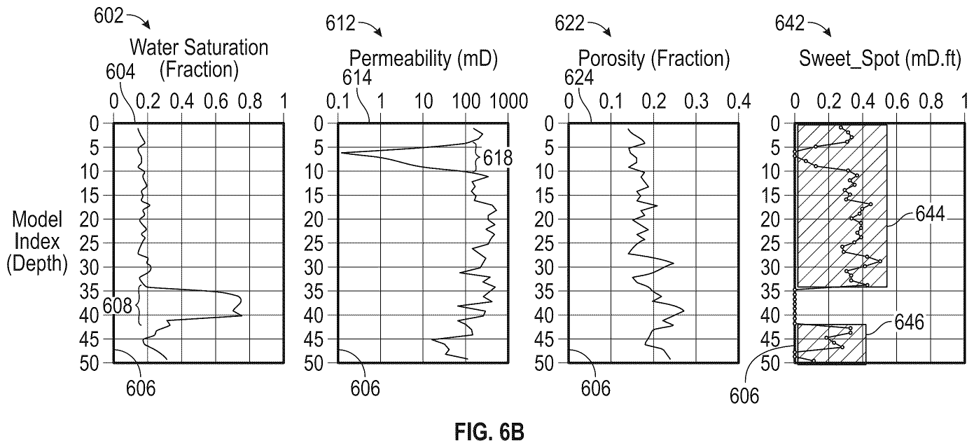

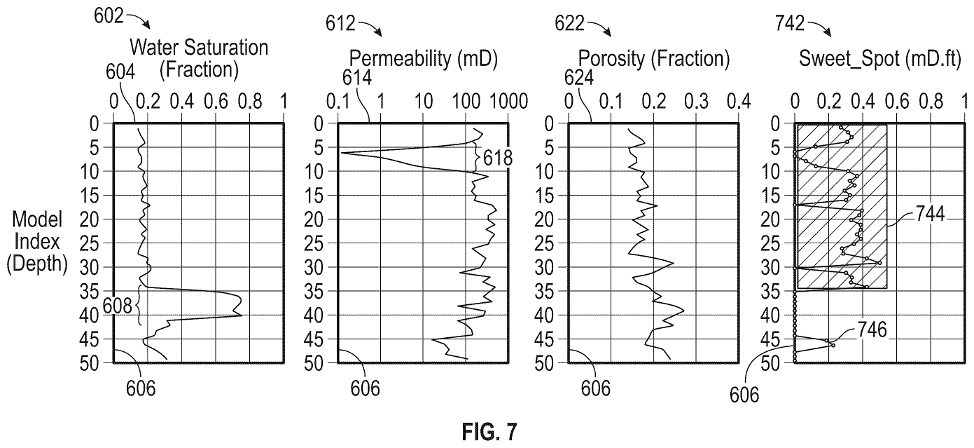

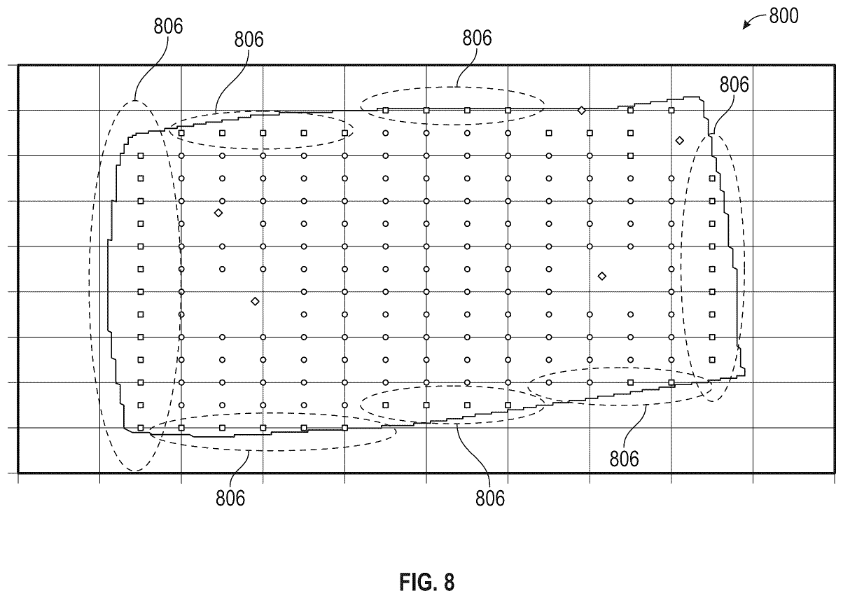

FIGS. 6A, 6B and 7 illustrates the determination of sweet-spots in accordance with one or more embodiments. Turning to FIG. 6A, chart (602) indicates water saturation as a fraction of total pore volume. Water saturation is indicated on the horizontal axis (604) for each of a plurality of model index location, representing depth, on the vertical axis (606). Note, the high water saturation zone (608), between model indices 35 and 42, that mitigates again this zone forming part of a sweet-spot.

Chart (612) indicates permeability. Permeability is indicated on the horizontal axis (614) for each of a plurality of model index location, representing depth, on the vertical axis (606). Note, the low permeability zone (618), between model indices 4 and 10, that mitigates again this zone forming part of a sweet-spot.

Chart (622) indicates porosity. Porosity is indicated on the horizontal axis (624) for each of a plurality of model index location, representing depth, on the vertical axis (606). While porosity increases somewhat from low model indices (shallower depths) to higher model indices (greater depths) there are no zones of anomalously high or low porosity.

Chart (632) indicates sweet-spot value. In some embodiments, the sweet-spot value may be determined by evaluating:

sweet-spot=porosity*log₁₀(permeability)*thickness*(1−S_{w}). Eqn. (5)

Applying a water saturation threshold of 0.25, a permeability threshold of 1 mD, a minimum target interval of 5, and a zone-merge threshold of 0, produces an upper sweet-spot (634) 5 cells thick, a middle sweet-spot (636) 27 cells thick, and a lower sweet-spot (638) 5 cells thick.

FIG. 6B shows the same charts (602), (612) and (622) as shown in FIG. 6A, and in the interests of brevity they will not be described again. However, FIG. 6B shows a new chart (642) distinct from chart (632). To obtain chart (642) new thresholds have been applied. Specifically, a water saturation threshold of 0.25, a permeability threshold of 1 mD, a minimum target interval of 5, and a zone-merge threshold of 0 have been used. As a result, an upper sweet-spot 35 cells thick and a lower sweet-spot 8 cells thick have been determined.

Both FIGS. 6A and 6B use the same water saturation threshold of 0.25. In contrast, FIG. 7 relates to the case where the water saturation threshold is selected to be 0.20.

FIGS. 6A and 6B indicate that the delineation of the sweet-spots may depend upon the threshold values selected. As in FIGS. 6A and 6B, charts (602), (612), and (622) are unchanged and, in the interests of brevity will not be described again. However, chart (742) is determined using a water saturation threshold of 0.20. As a result, only a single sweet-spot (744) 35 cells thick has been determined, while the lower peak on the curve (746) is only 2 cells thick (a thickness that falls below the minimum target interval of 5) and has not been determined to be a sweet-spot.

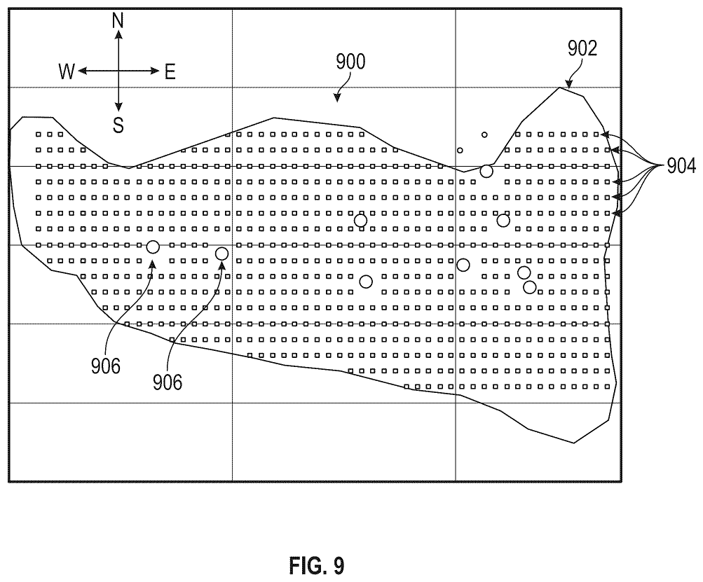

In still other embodiments, the workflow may be applied to undeveloped hydrocarbon reservoirs, also known as “green fields”, such as that shown in FIG. 8. In such case, the well design scenarios could consider the minimum thickness, the maximum water saturation, and the minimum permeability of reservoir intervals to be considered as potential targets, and well length. These different scenarios would result in different well counts and consequently in different recovery volumes.

In large reservoirs having significant vertical heterogeneities that require several hundreds of development wells, conducting these scenario evaluations could be time consuming, resulting in partial evaluation of scenarios whose results may not allow for optimum decision making. FIG. 8 shows a hypothetical green field reservoir (800) together with five hypothetical historic wells (802a-e) which may be exploration or appraisal wells. The boundary (804) of the green field reservoir (800) represents the surface projection of the boundary of the oil-water contact (608), marking the effective extent of the green field reservoir (800).

In some embodiments the following steps may be performed. In Step A, a uniform grid of vertical wells (806) may be defined covering the full extent of the green field reservoir. Only wells lying within the boundary of the free-water level contact are considered and they may be termed filtered field coverage wells (FFCW). The horizontal location of each FFCW may be stored, for example in computer readable memory. During Step A the water saturation, porosity and permeability logs of each of the FFCW wells may be automatically obtained.

In Step B, the FFCW adjacent to the green field reservoir boundary (800) may be determined and specified to be fluid injectors (806). The injected fluid may be water, and the injection may have the purpose of maintaining reservoir pressure and sweeping hydrocarbons towards production wells in the center of the reservoir.

In Step C embodiments may use an automated procedure to determine reservoir targets that meets user specified constraints. For example, it may automatically decide whether a given well location should be single or multi-laterals using evaluated sweet_spot values as described previously.

In Step D the location of each FFCW and sweet-spot interval in each well may be used to create well-grid connections for each sweet-spot zone. For FFCW having more than one interval, each lateral is treated as an individual well at this stage in order to be able to rank the production performance of each lateral.

In Step E, on completion of the simulation run, the production performance of all the laterals is screened to eliminate those with a cumulative production less than the user specified minimum threshold.

Finally, in Step F, a refined simulation run may be made comprising only the screened-in wells. This refined simulation run may indicate that the remaining wells may be able to produce hydrocarbon that previous simulation indicated would be produced by the screened-out wells thus providing a more accurate indication of total hydrocarbon production of the field.

These steps may help to quickly explore a wide range of possibilities and to form the basis of a field development strategy to be implemented. The automatic approach for comparing the production performance of these different user input scenarios would help to evaluate an exhaustive list of options and to subsequently formulate an optimum development strategy to be adopted during the field's developmental wells' drilling and completion.

The automated procedure may then use Eqn. (5) and one or more user defined parameters to identify reservoir sweet-spots and to determine the optimal depth and direction of the lateral. The lateral is created automatically and replaces the existing well in real simulation run time.

In some embodiments, evenly spaced vertical wells, such as wells (904), within a specified field boundary (902) may be defined, and wells adjacent to the boundary designated fluid injectors. The automated procedure may then determine reservoir targets that meets user specified constraints. For example, the automated procedure may automatically decide whether a given well location should be single well from the surface or a mother well with multi-laterals. In the latter case, the embodiment may reflect the multi-lateral status in the individual identification and naming of each lateral and also record which portion of the reservoir is penetrated by each lateral.

On completion of the automated procedure, all the laterals may be ranked and those with a cumulative production less than the user specified minimum eliminated. A new perforation record for the wells not eliminated may be generated for use in one or more subsequent refined simulation runs. In another example, in highly heterogeneous reservoirs where an interval containing high water saturation may separate two otherwise low water-saturation intervals, a proposed well may traverse a water saturation zone and therefore produce a high initial water-cut. Such a well may be eliminated by exceeding a user specified water-cut threshold.

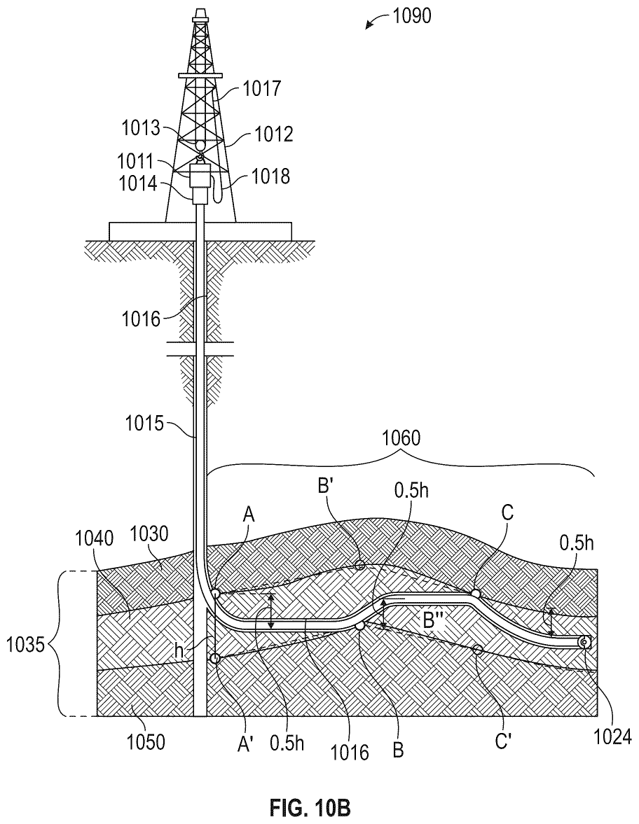

Once determined the planned production wells may be drilled using a drilling system, such as the drilling system (700). FIGS. 7A and 7B illustrate systems in accordance with one or more embodiments. As shown in FIG. 10A, a drilling system (700) may include a top drive drill rig (710) arranged around the setup of a drill bit logging tool (720). A top drive drill rig (710) may include a top drive (711) that may be suspended in a derrick (712) by a travelling block (713). In the center of the top drive (711), a drive shaft (714) may be coupled to a top pipe of a drill string (717), for example, by threads. The top drive (711) may rotate the drive shaft (714), so that the drill string (715) and a drill bit logging tool (720) cut the rock at the bottom of a wellbore (716). A power cable (717) supplying electric power to the top drive (711) may be protected inside one or more service loops (718) coupled to a control system (744). As such, drilling mud may be pumped into the wellbore (716) through a mud line, the drive shaft (714), and/or the drill string (715).

Moreover, when completing a well, casing may be inserted into the wellbore (716). The sides of the wellbore (716) may require support, and thus the casing may be used for supporting the sides of the wellbore (716). As such, a space between the casing and the untreated sides of the wellbore (716) may be cemented to hold the casing in place. The cement may be forced through a lower end of the casing and into an annulus between the casing and a wall of the wellbore (716). More specifically, a cementing plug may be used for pushing the cement from the casing. For example, the cementing plug may be a rubber plug used to separate cement slurry from other fluids, reducing contamination and maintaining predictable slurry performance. A displacement fluid, such as water, or an appropriately weighted drilling mud, may be pumped into the casing above the cementing plug. This displacement fluid may be pressurized fluid that serves to urge the cementing plug downward through the casing to extrude the cement from the casing outlet and back up into the annulus.

As further shown in FIG. 10A, sensors (721) may be included in a sensor assembly (723), which is positioned adjacent to a drill bit (724) and coupled to the drill string (715). Sensors (721) may also be coupled to a processor assembly (723) that includes a processor, memory, and an analog-to-digital converter (722) for processing sensor measurements. For example, the sensors (721) may include acoustic sensors, such as accelerometers, measurement microphones, contact microphones, and hydrophones. Likewise, the sensors (721) may include other types of sensors, such as transmitters and receivers to measure resistivity, gamma ray detectors, etc. The sensors (721) may include hardware and/or software for generating different types of well logs (such as acoustic logs or density logs) that may provide well data about a wellbore, including porosity of wellbore sections, gas saturation, bed boundaries in a geologic formation, fractures in the wellbore or completion cement, and many other pieces of information about a formation. If such well data is acquired during drilling operations (i.e., logging-while-drilling), then the information may be used to make adjustments to drilling operations in real-time. Such adjustments may include rate of penetration (ROP), drilling direction, altering mud weight, and many others drilling parameters.

In some embodiments, acoustic sensors may be installed in a drilling fluid circulation system of a drilling system (700) to record acoustic drilling signals in real-time. Drilling acoustic signals may transmit through the drilling fluid to be recorded by the acoustic sensors located in the drilling fluid circulation system. The recorded drilling acoustic signals may be processed and analyzed to determine well data, such as lithological and petrophysical properties of the rock formation. This well data may be used in various applications, such as steering a drill bit using geosteering, casing shoe positioning, etc.

The control system (744) may be coupled to the sensor assembly (723) in order to perform various program functions for up-down steering and left-right steering of the drill bit (724) through the wellbore (716). More specifically, the control system (744) may include hardware and/or software with functionality for geosteering a drill bit through a formation in a lateral well using sensor signals, such as drilling acoustic signals or resistivity measurements. For example, the formation may be a reservoir region, such as a pay zone, bed rock, or cap rock.

Turning to geosteering, geosteering may be used to position the drill bit (724) or drill string (715) relative to a boundary between different subsurface layers (e.g., overlying, underlying, and lateral layers of a pay zone) during drilling operations. In particular, measuring rock properties during drilling may provide the drilling system (700) with the ability to steer the drill bit (724) in the direction of desired hydrocarbon concentrations. As such, a geosteering system may use various sensors located inside or adjacent to the drilling string (715) to determine different rock formations within a wellbore's path. In some geosteering systems, drilling tools may use resistivity or acoustic measurements to guide the drill bit (724) during horizontal or lateral drilling.

Turning to FIG. 10B, FIG. 10B illustrates some embodiments for steering a drill bit through a lateral pay zone using a geosteering system (790). As shown in FIG. 10B, the geosteering system (790) may include the drilling system (700) from FIG. 10A. In particular, the geosteering system (790) may include functionality for monitoring various sensor signatures (e.g., an acoustic signature from acoustic sensors) that gradually or suddenly change as a well path traverses a cap rock (730), a pay zone (740), and a bed rock (750). Because of the sudden change in lithology between the cap rock (730) and the pay zone (740), for example, a sensor signature of the pay zone (740) may be different from the sensor signature of the cap rock (730). When the drill bit (724) drills out of the pay zone (740) into the cap rock (730), a detected amplitude spectrum of a particular sensor type may change suddenly between the two distinct sensor signatures. In contrast, when drilling from the pay zone (740) downward into the bed rock (750), the detected amplitude spectrum may gradually change.

During the lateral drilling of the wellbore (716), preliminary upper and lower boundaries of a formation layer's thickness may be derived from a geophysical survey and/or an offset well obtained before drilling the wellbore (716). If a vertical section (735) of the well is drilled, the actual upper and lower boundaries of a formation layer (i.e., actual pay zone boundaries (A, A′)) and the pay zone thickness (i.e., A to A′) at the vertical section (735) may be determined. Based on this well data, an operator may steer the drill bit (724) through a lateral section (760) of the wellbore (716) in real time. In particular, a logging tool may monitor a detected sensor signature proximate the drill bit (724), where the detected sensor signature may continuously be compared against prior sensor signatures, e.g., of the cap rock (730), pay zone (740), and bed rock (750), respectively. As such, if the detected sensor signature of drilled rock is the same or similar to the sensor signature of the pay zone (740), the drill bit (724) may still be drilling in the pay zone (740). In this scenario, the drill bit (724) may be operated to continue drilling along its current path and at a predetermined distance (0.5 h) from a boundary of a formation layer. If the detected sensor signature is same as or similar to the prior sensor signatures of the cap rock (730) or the bed rock (750), respectively, then the control system (744) may determine that the drill bit (724) is drilling out of the pay zone (740) and into the upper or lower boundary of the pay zone (740). At this point, the vertical position of the drill bit (724) at this lateral position within the wellbore (716) may be determined and the upper and lower boundaries of the pay zone (740) may be updated, (for example, positions B and C in FIG. 10B). In some embodiments, the vertical position at the opposite boundary may be estimated based on the predetermined thickness of the pay zone (740), such as positions B′ and C′.

While FIGS. 7A, and 7B shows various configurations of components, other configurations may be used without departing from the scope of the disclosure. For example, various components in FIGS. 7A, and 7B may be combined to create a single component. As another example, the functionality performed by a single component may be performed by two or more components.

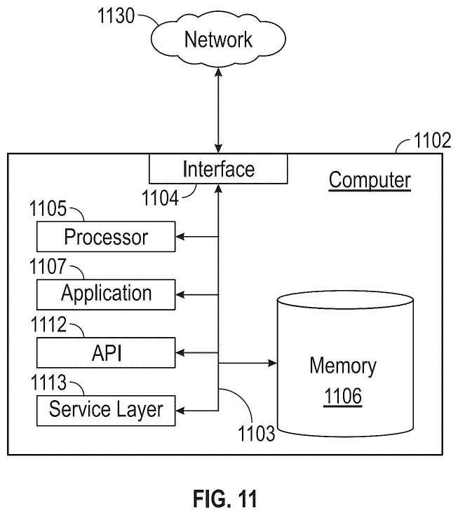

Seismic processing system, reservoir modeling system, and reservoir simulators may each require a computer system together specialized software configured to perform the steps specific to each system. FIG. 11 depicts a block diagram of such a computer system (1102) used to provide computational functionalities associated with described algorithms, methods, functions, processes, flows, and procedures as described in this disclosure, according to one or more embodiments. The illustrated computer (1102) is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (1102) may include a computer that includes an input device, such as a keypad, keyboard, touch screen, or other device that can accept user information, and an output device that conveys information associated with the operation of the computer (1102), including digital data, visual, or audio information (or a combination of information), or a GUI.

More specifically, the computer system (1102) used by this invention has a multi-node, multi-thread processor capable of running multiple threads (202) in parallel. This computer system (1102) may run the message passing interface (MPI) library of functions, or any software library with similar functionality. Algorithms run on this parallel computer system (1102) may operate by a divide-and-conquer strategy, where data may be subdivided and sent to the different nodes to be processed, and then the results recombined. Buffers may be used on the computer system (1102) to hold data before, during, or after processing. Temporary files may be used to hold intermediate results and allow for further manipulation of data. Shared disks (304) may also be used by the computer system (1102) as a central location to store data being used simultaneously by several nodes.

The computer (1102) can serve in a role as a client, network component, a server, a database or other persistency, or any other component (or a combination of roles) of a computer system for performing the subject matter described in the instant disclosure. The illustrated computer (1102) is communicably coupled with a network (1130). In some implementations, one or more components of the computer (1102) may be configured to operate within environments, including cloud-computing-based, local, global, or other environment (or a combination of environments).

At a high level, the computer (1102) is an electronic computing device operable to receive, transmit, process, store, or manage data and information associated with the described subject matter. According to some implementations, the computer (1102) may also include or be communicably coupled with an application server, e-mail server, web server, caching server, streaming data server, business intelligence (BI) server, or other server (or a combination of servers).

The computer (1102) can receive requests over network (1130) from a client application (for example, executing on another computer (1102) and responding to the received requests by processing the said requests in an appropriate software application. In addition, requests may also be sent to the computer (1102) from internal users (for example, from a command console or by other appropriate access method), external or third-parties, other automated applications, as well as any other appropriate entities, individuals, systems, or computers.

Each of the components of the computer (1102) can communicate using a system bus (1103). In some implementations, any or all of the components of the computer (1102), both hardware or software (or a combination of hardware and software), may interface with each other or the interface (1104) (or a combination of both) over the system bus (1103) using an application programming interface (API) (1112) or a service layer (1113) (or a combination of the API (1112) and service layer (1113). The API (1112) may include specifications for routines, data structures, and object classes. The API (1112) may be either computer-language independent or dependent and refer to a complete interface, a single function, or even a set of APIs. The service layer (1113) provides software services to the computer (1102) or other components (whether or not illustrated) that are communicably coupled to the computer (1102). The functionality of the computer (1102) may be accessible for all service consumers using this service layer. Software services, such as those provided by the service layer (1113), provide reusable, defined business functionalities through a defined interface. For example, the interface may be software written in JAVA, C++, or other suitable language providing data in extensible markup language (XML) format or another suitable format. While illustrated as an integrated component of the computer (1102), alternative implementations may illustrate the API (1112) or the service layer (1113) as stand-alone components in relation to other components of the computer (1102) or other components (whether or not illustrated) that are communicably coupled to the computer (1102). Moreover, any or all parts of the API (1112) or the service layer (1113) may be implemented as child or sub-modules of another software module, enterprise application, or hardware module without departing from the scope of this disclosure.

The computer (1102) includes an interface (1104). Although illustrated as a single interface (1104) in FIG. 11, two or more interfaces (1104) may be used according to particular needs, desires, or particular implementations of the computer (1102). The interface (1104) is used by the computer (1102) for communicating with other systems in a distributed environment that are connected to the network (1130). Generally, the interface (1104) includes logic encoded in software or hardware (or a combination of software and hardware) and operable to communicate with the network (1130). More specifically, the interface (1104) may include software supporting one or more communication protocols associated with communications such that the network (1130) or interface's hardware is operable to communicate physical signals within and outside of the illustrated computer (1102).

The computer (1102) includes at least one computer processor (1105). Although illustrated as a single computer processor (1105) in FIG. 11 two or more processors may be used according to particular needs, desires, or particular implementations of the computer (1102). Generally, the computer processor (1105) executes instructions and manipulates data to perform the operations of the computer (1102) and any algorithms, methods, functions, processes, flows, and procedures as described in the instant disclosure.

The computer (1102) also includes a memory (1106), including non-transitory computer readable memory, that holds instructions and data for the computer (1102) or other components (or a combination of both) that can be connected to the network (1130). For example, memory (1106) can be a database storing data consistent with this disclosure. Although illustrated as a single memory (1106) in FIG. 11, two or more memories may be used according to particular needs, desires, or particular implementations of the computer (1102) and the described functionality. While memory (1106) is illustrated as an integral component of the computer (1102), in alternative implementations, memory (1106) can be external to the computer (1102).

The application (1107) is an algorithmic software engine providing functionality according to particular needs, desires, or particular implementations of the computer (1102), particularly with respect to functionality described in this disclosure. For example, application (1107) can serve as one or more components, modules, applications, etc. Further, although illustrated as a single application (1107), the application (1107) may be implemented as multiple applications (1107) on the computer (1102). In addition, although illustrated as integral to the computer (1102), in alternative implementations, the application (1107) can be external to the computer (1102).

There may be any number of computers (1102) associated with, or external to, a computer system containing computer (1102), wherein each computer (1102) communicates over network (1130). Further, the term “client,” “user,” and other appropriate terminology may be used interchangeably as appropriate without departing from the scope of this disclosure. Moreover, this disclosure contemplates that many users may use one computer (1102), or that one user may use multiple computers (1102).

Although only a few example embodiments have been described in detail above, those skilled in the art will readily appreciate that many modifications are possible in the example embodiments without materially departing from this invention.

What is claimed:

1. A method comprising,
using a reservoir simulator:
obtaining a reservoir simulation model for a hydrocarbon reservoir, wherein the reservoir simulation model comprises a grid of computational voxels representing the hydrocarbon reservoir, a free-water level boundary, and a location of each of a plurality of pre-existing production wells,
defining a location for each of a plurality of candidate wells, wherein the location for each of the plurality of candidate wells lies within an area enclosed by the free-water level boundary,
forming a first filtered set of candidate well from the plurality of candidate wells, wherein a distance between a location of each well in the first filtered set and the location of each pre-existing production well in the plurality of pre-existing wells is greater than a first threshold distance;
forming a set of candidate production well locations from the first filtered set, wherein each candidate well location in the set of candidate production well locations is further than a second threshold distance from the free-water level boundary,
using the reservoir simulation model, for each candidate production well location in the set of candidate production well locations:
determining a trajectory for each of a number of lateral branches of a well commencing at the location of the candidate production well; and
determining, using the trajectory for each of the lateral branches of the well, a combined predicted production rate,
ranking the candidate production well locations based, at least in part, on the combined predicted production rate of each candidate production well location;
selecting a set of planned production well locations based, at least in part on the rank of each candidate production well locations; and
drilling, using a drilling system, a production well guided by the trajectory of each lateral branch of the well commencing at the candidate production well location.

2. The method of claim 1, wherein determining a trajectory comprises:
determining sweet-spot voxels beneath the candidate production well location, wherein sweet-spot voxels comprise computational voxel with a permeability greater a permeability threshold, and a water saturation threshold less than a water saturation threshold;
determining sweet-spot layers by merging sweet-spot voxels separated from one another by less than a depth separation threshold;
selecting sweet-spot layers with a thickness greater than a thickness threshold; and
determining a trajectory for each sweet-spot layer in a user specified direction and with a user specified length.

3. The method of claim 2, wherein defining the location for each of the plurality of candidate wells further comprises:
defining a regularly grid of locations throughout an area wholly enclosing the free water level boundary; and
selecting the plurality of candidate well locations from the regular grid, wherein the location for each of the plurality of candidate wells lies within the area enclosed by the free-water level boundary.

4. The method of claim 1, further comprising:
updating, using the reservoir simulator, the predicted combined production rate for each candidate production well location based, at least in part, on the set of planned production well locations and the reservoir simulation model.

5. The method of claim 1, further comprising:
forming a set of candidate injection well locations from the first filtered set of candidate well locations, wherein each candidate well location in the set of candidate injection well locations is closer than a second threshold distance to the free-water level boundary; and
forming a set of injection well locations, wherein each injection well location in the set of injection well locations occupies a position on the free-water level boundary closest to its corresponding candidate injection well location in the set of candidate injection well locations.

6. The method of claim 1, wherein drilling the trajectory of each lateral branch comprises performing geosteering.

7. The method of claim 1, wherein the reservoir simulator comprises a physics-based reservoir simulator.

8. The method of claim 1, wherein the production of each of the set of planned production wells exceeds a predetermined performance threshold.

9. The method of claim 1, wherein the number of lateral branches exceeds one.

10. The method of claim 1, wherein drilling the production well comprises a drilling multilateral well geometry.

11. A system comprising:
a reservoir simulator, configured to:
obtain a reservoir simulation model for a hydrocarbon reservoir, wherein the reservoir simulation model comprises a grid of computational voxels representing the hydrocarbon reservoir, a free-water level boundary, and a location of each of a plurality of pre-existing production wells,
define a location for each of a plurality of candidate wells, wherein the location for each of the plurality of candidate wells lies within an area enclosed by the free-water level boundary,
form a first filtered set of candidate well from the plurality of candidate wells, wherein a distance between a location of each well in the first filtered set and the location of each pre-existing production well in the plurality of pre-existing wells is greater than a first threshold distance;
form a set of candidate production well locations from the first filtered set, wherein each candidate well location in the set of candidate production well locations is further than a second threshold distance from the free-water level boundary,
using the reservoir simulation model, for each candidate production well location in the set of candidate production well locations:
determine, using the reservoir simulation model, a trajectory for each of a number of lateral branches of a well commencing at the location of the candidate production well; and
determine, using the trajectory for each of the lateral branches of the well, a combined predicted production rate,
rank the candidate production well locations based, at least in part, on the combined predicted production rate of each candidate production well location;
select a set of planned production well locations based, at least in part on the rank of each candidate production well locations; and
a drilling system, configured to drill a production well guided by the trajectory of each lateral branch of the well commencing at the candidate production well location.

12. The system of claim 11, wherein configured to determine a trajectory comprises configured to:
determine sweet-spot voxels beneath the candidate production well location, wherein sweet-spot voxels comprise computational voxel with a permeability greater a permeability threshold, and a water saturation threshold less than a water saturation threshold;
determine sweet-spot layers by merging sweet-spot voxels separated from one another by less than a depth separation threshold;
select sweet-spot layers with a thickness greater than a thickness threshold; and
determine a trajectory for each sweet-spot layer in a user specified direction and with a user specified length.

13. The system of claim 12, wherein configured to define the location for each of the plurality of candidate wells further comprises configure to:
define
a regularly grid of locations throughout an area wholly enclosing the free water level boundary; and
select the plurality of candidate well locations from the regular grid, wherein the location for each of the plurality of candidate wells lies within the area enclosed by the free-water level boundary.

14. The system of claim 11, wherein the reservoir simulator is further configured to:
update the predicted combined production rate for each candidate production well location based, at least in part, on the set of planned production well locations and the reservoir simulation model.

15. The system of claim 11, wherein the reservoir simulator is further configured to:
form a set of candidate injection well locations from the first filtered set of candidate well locations, wherein each candidate well location in the set of candidate injection well locations is closer than a second threshold distance to the free-water level boundary; and
form a set of injection well locations, wherein each injection well location in the set of injection well locations occupies a position on the free-water level boundary closest to its corresponding candidate injection well location in the set of candidate injection well locations.

16. The system of claim 11, wherein drilling the trajectory of each lateral branch comprises performing geosteering.

17. The system of claim 11, wherein the reservoir simulator comprises a physics-based reservoir simulator.

18. The system of claim 11, wherein the production of each of the set of planned production wells exceeds a predetermined performance threshold.

19. The system of claim 11, wherein drilling the production well comprises a drilling multilateral well geometry.

20. A non-transitory computer-readable memory comprising computer-executable instructions stored thereon that, when executed on a processor, cause the processor to perform steps comprising:
obtaining a reservoir simulation model for a hydrocarbon reservoir, wherein the reservoir simulation model comprises a grid of computational voxels representing the hydrocarbon reservoir, a free-water level boundary, and a location of each of a plurality of pre-existing production wells,
defining a location for each of a plurality of candidate wells, wherein the location for each of the plurality of candidate wells lies within an area enclosed by the free-water level boundary,
forming a first filtered set of candidate well from the plurality of candidate wells, wherein a distance between a location of each well in the first filtered set and the location of each pre-existing production well in the plurality of pre-existing wells is greater than a first threshold distance;
forming a set of candidate production well locations from the first filtered set, wherein each candidate well location in the set of candidate production well locations is further than a second threshold distance from the free-water level boundary,
using the simulation model, for each candidate production well location in the set of candidate production well locations:
determining a trajectory for each of a number of lateral branches of a well commencing at the location of the candidate production well; and
determining, using the trajectory for each of the lateral branches of the well, a combined predicted production rate,
ranking the candidate production well locations based, at least in part, on the combined predicted production rate of each candidate production well location;
selecting a set of planned production well locations based, at least in part on the rank of each candidate production well locations.
